(19) United States
(12) Patent Application Publication
(10) Pub. No.: US 2010/0023172 A1
(43) Pub. Date: Jan. 28, 2010

(54) System And Method For Wireless Networked Control Of Consumer Utility Consumption

(76) Inventor: Michele R.B. Malinowski, Hartford, WI (US)

Correspondence Address: BOYLE FREDRICKSON S.C., 840 North Plankinton Avenue, MILWAUKEE, WI, 53203, US

(21) Appl. No.: 12/179,947

(22) Filed: Jul. 25, 2008

(51) Int. Cl. G05D 7/06

(52) U.S. Cl. 700/283

(57) ABSTRACT

A system and method for sending wireless control signals from a system control unit (24) to operate valve assemblies (13, 14, 15, or 16) in a utility supply system to restrict usage based on a schedule determined by the utility provider and without interrupting essential utility services. The system control unit (24) is carried in a vehicle (21) or by a person. The wireless control signals can include data to close a valve, data to open a valve, a schedule for opening and closing one or more valves, a usage limit or flow rate limit a schedule for reporting status or settings to mitigate leakage. The valve assemblies (13, 14, 15, or 16) can also read in current usage totals from a meter (12) for comparison with usage criteria stored in the valve assemblies (13, 14, 15, or 16).

### TECHNICAL FIELD

The invention relates to wireless control systems for controlling or restricting the supply of a utility such as water or gas to various consumer systems utilizing the utility.

### DESCRIPTION OF THE BACKGROUND ART

Kates, U.S. Pat. No. 7,228,726, discloses a system for monitoring water use or detecting leaks where water is supplied to a plurality of sprinklers. A controller provides control signals to the sprinkler valves and to the monitoring system. An output from a flow meter is also provided to the monitoring system. The monitoring system monitors and records water flow through each of the valves by recording water flow data from the flow meter when each of the valves is opened.

Addink et al., U.S. Pat. No. 6,944,523, discloses an irrigation controller that reads water, gas and electric meters and communicates metering data over a network including irrigation nodes with valves for turning on and shutting off supply of the utility under a schedule set by the utility customer. If the customer exceeds the water use restrictions, a “reminder” is sent by the utility to the customer.

Cardinal et al., U.S. Pat. Pub. No. US2004/0181315, discloses an irrigation control system for computing a schedule to send to an irrigation control circuit.

Nelson et al, U.S. Pat. Pub. No. US2006/0030971, discloses a modular controller for controlling an irrigation system and for communicating with utility meters.

Doering et al., Pat. Pub. No. US2007/035907, discloses an irrigation valve controller for controlling an irrigation valve in a subsurface enclosure of a type used for utility meters. This patent discusses the details of the irrigation controller and how it can receive signals from many devices.

Ensworth, U.S. Pat. Pub. No. US2007/0106426, discloses a controller for controlling irrigation stations through a wireless network.

Cerny et al., U.S. Pat. No. 5,298,894, discloses a mobile automatic meter reading (AMR) system with communication to a drive-by vehicle or a person on foot carrying a data collection unit.

There are various reasons for shutting off or restricting usage of utility service such as to protect the utility system or property in an emergency response situation, or to conserve the utility in times of shortage.

### SUMMARY OF THE INVENTION

The invention provides a system and method for sending wireless control signals to a controller to operate a fluid control device in a utility supply system to restrict usage based on a schedule determined by the utility provider and without interrupting essential utility services.

In its broadest aspects, the utility is a fluid, preferably, water, but the fluid could also be natural gas or propane gas. In its broadest aspects, the network could be fixed or mobile, with a first example being a mobile system for water.

In a more particular aspect of the invention, a monitoring and control system of the type used for automatic meter reading and irrigation control is used to restrict usage of the utility in non-critical uses.

A system control unit communicates with meters used to monitor consumption of the utility and with fluid control devices used to control supply of the utility to various user devices. The communication is preferably wireless, using radio frequency (RF) signals, infrared (IR) signals, electromagnetic coupling signals or inductive coupled signals. The system control unit is preferably mobile, using a vehicle or a person to carry a reader and control unit. The vehicle system is sometimes referred to as a “drive-by” system and the other system is sometimes referred to as a “walk-by” system. The system control unit will communicate commands from the utility to the individual fluid control devices, and return any responses (also known as “status”) to the utility.

The fluid control devices respond to a variety of commands received from the system control unit to indicate status, or to open or close on demand, allowing the utility to override a customer's settings during periods of necessary conservation. In one example, a water utility can shut off access to irrigation at any point to restrict supply of the utility in times of drought or water shortage.

The invention is very advantageous over prior systems in allowing a utility to override user settings in a user service link to the distribution system without interrupting essential services.

Other objects and advantages of the invention, besides those discussed above, will be apparent to those of ordinary skill in the art from the description of the preferred embodiments which follows. In the description, reference is made to the accompanying drawings, which form a part hereof, and which illustrate examples of the invention.

### BRIEF DESCRIPTION OF THE DRAWINGS

FIG. 1 is a schematic diagram of a system for controlling valves in a water supply system;

FIG. 2 is a schematic diagram of a combined AMR and control system for water supply valves;

FIG. 3 is a schematic diagram of an individual water supply valve with an RF transceiver module attached; and

FIG. 4 is a block diagram of the RF transceiver module of FIG. 3.

### DETAILED DESCRIPTION OF THE PREFERRED EMBODIMENTS

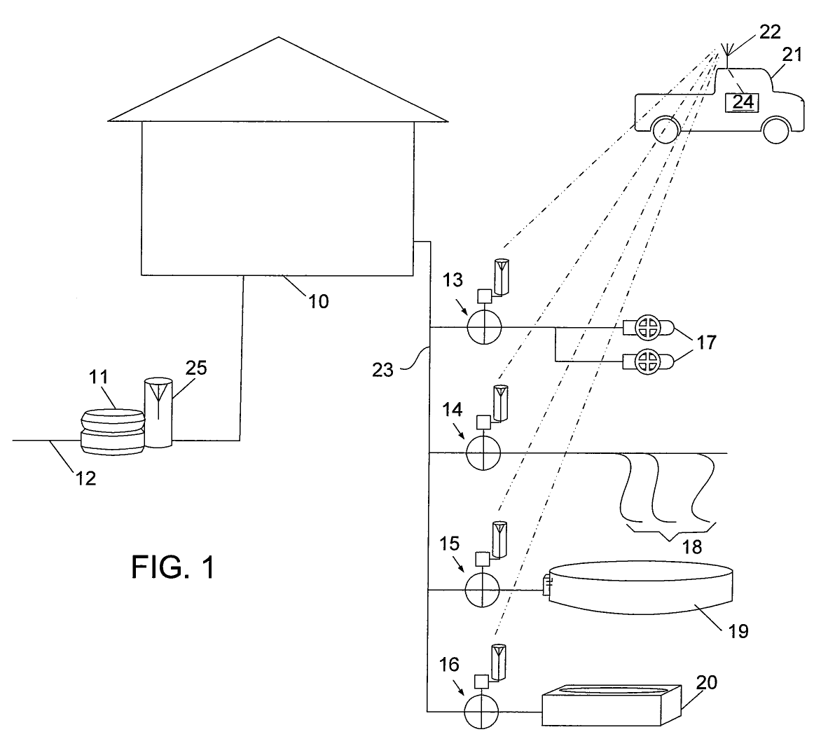

Referring to FIG. 1, in a preferred embodiment, a water supply system in a building 10 has a water meter 11 in an intake pipe line 12 for the water utility and a plurality of electronically controlled valve assemblies 13, 14, 15 and 16 in outlet distribution lines 23 supplying hose connections 17, an irrigation system (including a sprinkler system) 18, a swimming pool 19 and a spa tub 20. The water meter 11 can be connected in a water supply line within a building, but in warmer climates, where basements are not available, it is the practice to place water meter equipment outside the building 10 in a subsurface pit enclosure (not shown) in a yard or other available area, as is known in the art.

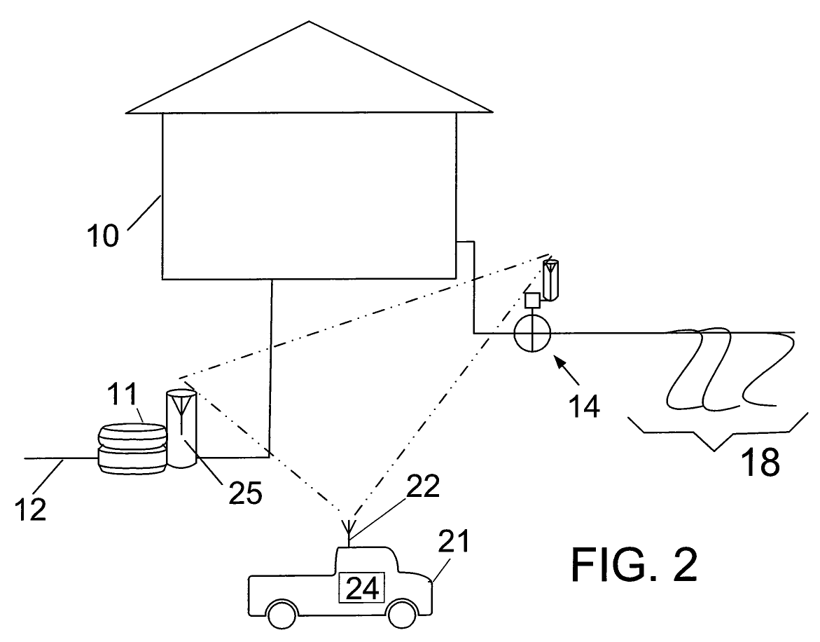

As seen in FIG. 2, a utility-authorized vehicle 21 has a system control unit 24 with an antenna 22 for receiving radio frequency (RF) signals from the water meter 11 through an associated transmitter 25 and for transmitting radio frequency (RF) signals to the control valves, such as control valve 14 illustrated in FIG. 2. The system control unit 24 can be two-way with signals being transmitted to the control valve assemblies 13-16 and with signals being received from the water meter 11.

The mobile system control unit 24 in the vehicle 21 can be an Orion® receiver, adapted in this case for providing transmissions with limited command signals as well as receiving RF signals with meter data. This Orion® system control unit 24 has previously been commercially offered by the assignee of the present invention, but not with the features of the invention described herein. Besides signaling radio frequency (RF) signals, the system control unit 24 receives meter data, and certain status data of a type known in the art. This meter data and status data can then be transferred to a laptop computer also located in the vehicle 21.

The system control unit can also be a handheld receiver carried by a service technician. These receivers are carried along a route for collection of utility metering data. In the case of the handheld device, this is carried back to a site where the device is placed in a pedestal including an electrical connector and the meter data is unloaded to a personal computer. For both types of radio control units, the system control unit transmits an electronic message that includes at least an identification code, meter reading data, and an error code for checking the data at the receiving end. In addition other types of status data, such as tamper indication data, can be included in the message. The utility consumption data is collected from meters at various customer locations for billing purposes.

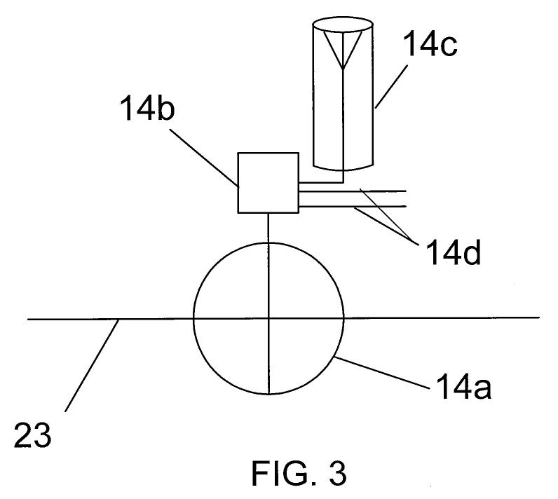

As seen in FIG. 3, one of the electronically controlled valve assemblies 13-16 is illustrated with a valve 14a, a controller 14b, an antenna 14c and outputs 14d, the other valve assemblies 13, 15 and 16 also including these components. The valve 14a is located in the one of the outgoing supply lines 23 for actuation in response to signals from the controller 14b. The controller 14b and the valve 14a are situated in a distribution line 23 supplying a user device, in this case an irrigation system 18, such that closing the valve 14a stops the supply of water to the irrigation system 18, without interrupting the supply through the meter 11 or to essential portions of a customer utility service in the building 10. Preferably the valve 14a is energized for a short period either to open or to close, so that a steady state current is not required. This is one type of actuation. Another type of actuation is an actuation to open or close the valve and a de-actuation or de-energization to operate the valve in the opposite state. This is all deemed to be within the broad term of “actuation” or “operation” as used herein. Opening the valve allows the supply of water to end use devices, while closing the valve shuts off this supply. The controller 14b also provides outputs 14d for signaling pumps (not shown) in the supply line to stop operating while the valve 14a is closed.

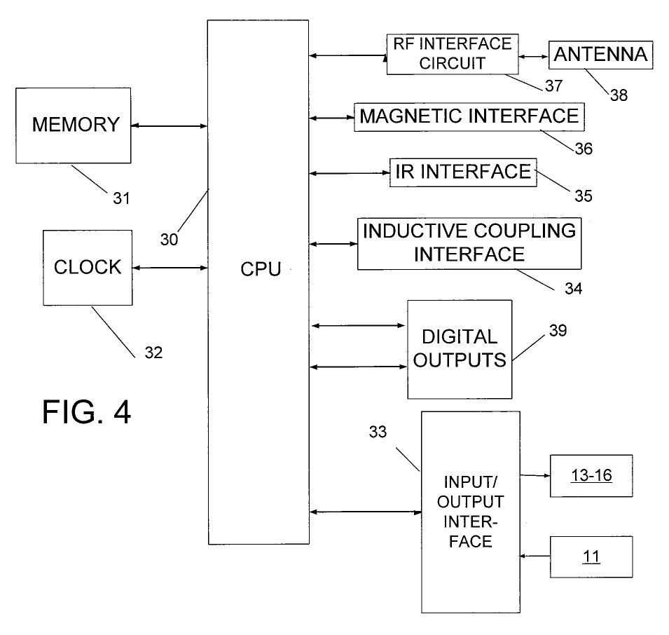

Referring to FIG. 4, a valve controller 14b also includes an electrical circuit typically formed on a circuit board and including a microelectronic central processor unit (CPU) 30 operating in response to clock signals from a clock circuit 31 and operating according to a control program stored in a program memory 32, which in this case is a flash memory or other type of non-volatile memory. The CPU 30 is electrically connected to input/output interface section 33. This section 33 will receive signals from an electronic metering device 11 or transmit and receive signals to and from the valve assemblies 13-16 to operate the valve assemblies 13-16 as well as to sense the current status of the valves as open or closed. As further seen in FIG. 4, the CPU 30 receives signals from a wireless control system through one of four interfaces 34, 35, 36 or 37. The CPU 30 receives signals through an inductive coupling interface 34, an infrared (IR) interface 35 or an electromagnetic coupling interface 36, or preferably a radio frequency (RF) interface circuit 37. The RF interface circuit 37 transmits and receives data in a message protocol, which is converted to radio frequency (RF) signals through modulation and from RF signals by demodulation. The signals are transmitted and received through an antenna 38. The controller 14b also includes an output interface 39 to transmit signals to shut off downstream equipment such as pumps.

Through the RF interface circuit 37, the controller 14b (FIG. 3) can both receive and transmit RF signals through antenna 14c in a wireless network. The controller 14b will normally receive a message in the 902-928 Mhz frequency band, but other frequencies known in the art can also be used for the radio communications.

The controllers in the valve assemblies 13-16 are normally in an idle state, waiting for one or more commands from the system control unit 24 in the vehicle 21. Once a message is received, the CPU 30 determines whether or not the serial number matches that of the message addressee. If the addressee serial number matches, the CPU 30 parses the message and determines what actions to take. Actions may include actuating the valve 14a to close or to open, changing programmed settings for valve actuations, changing a programmed schedule of valve actuations, and reporting of status data.

The controller 14b is electrically connected to an electrically operable actuator to actuate the valve 14a in response to receiving wireless control signals from the system control unit 24 in the drive-by vehicle 21. The wireless control signals can include data comprising a command to close a valve, a command to open a valve, a schedule for opening and closing one or more valves, a usage limit or flow rate limit a schedule for reporting status or settings to mitigate leakage. The system control unit 24 in FIGS. 1 and 2 can also read in current usage totals from the meter 11 for comparison with usage criteria stored in the system control unit 24. The metering data can also be forwarded to the controller 14b for controlling the valve 14a based on a comparison with usage criteria stored in the controller 14b. In FIG. 2, the meter 11 can transmit current usage totals through the transmitter 25 to the valve assembly 14, including controller 14b controlling the valve 14a in FIG. 3, for comparison with usage criteria. The controller 14b can the enforce usage restrictions by closing the valve 14a for scheduled periods when necessary. In addition, in all of the examples just given, the controller 14b may provide output signals through the output interface 39 (FIG. 4) and outputs 14d (FIG. 3) to shut off devices downstream of the valves 13-16, such as pumps.

Valve actuations can be scheduled on an hourly, daily or weekly basis, or for other intervals or for “no use” periods to respond to weather-related usage restrictions, peak demand restrictions or emergency responses. Scheduled actuations can also include periodic operations for maintenance and reliability of the equipment.

This has been a description of the preferred embodiments, but it will be apparent to those of ordinary skill in the art that variations may be made in the details of these specific embodiments. Such are intended to be encompassed by the broadest aspects of the present invention unless excluded by the following claims.

1. A system for wireless transmission of signals to restrict consumption of a utility, the system comprising:
at least one fluid control device for connection in an outlet line supplying the utility to a customer device using that utility;
wherein the at least one fluid control device includes a controller for opening and closing the fluid control device, the fluid control device being positioned such that actuating the fluid control device to stop supply to the customer device does not interrupt supply of the utility to a main customer service;
wherein the controller operates the fluid control device in response to receiving wireless control signals from a system control unit; and
wherein the controller operates the fluid control device to implement a schedule received from the system control unit.

2. The system as recited in claim 1, wherein the system control unit is mobile and transmits signals to the controller to provide a schedule of actuations for the fluid control device that override any prior schedule of a customer.

3. The system as recited in claim 2, wherein the utility is water and the schedule includes at least one of weather-related restrictions, peak demand restrictions or emergency conditions.

4. The system as recited in claim 2, wherein the utility is water, the fluid control device is a valve and wherein the schedule is arranged for periodic actuations of the valve for maintenance reasons.

5. The system as recited in claim 1, wherein the utility is water and the fluid control device is a valve situated in an outlet line supplying a customer device such that closing the valve does not stop supply to a meter on the main customer service.

6. The system as recited in claim 1, wherein the customer device is at least one of a swimming pool, a spa and a hose outlet.

7. The system as recited in claim 1, wherein the fluid control device is capable of transmitting signals to shut off downstream devices using the utility when the fluid control device is signaled to stop supply of the utility through the fluid control device.

8. The system as recited in claim 1, further comprising a meter for transmitting current usage totals to the system control unit for comparison with usage criteria in at least one of the system control unit and the controller.

9. The system as recited in claim 1, further comprising a meter on the main customer service transmitting current usage totals to the controller controlling the fluid control device for comparison with usage criteria.

10. The system of claim 1, wherein the system control unit is a radio signaling unit carried by a vehicle.

11. The system of claim 1, wherein the system control unit is carried by a person collecting meter data collection on foot.

12. A method for wireless transmission of signals to restrict consumption of a utility, the method comprising:
positioning at least one fluid control device in a distribution line supplying the utility from a main customer service to a customer device using that utility;
operating the fluid control device to supply the customer device with the utility and operating the fluid control device to stop the supply of the utility to the customer device without interrupting supply to the main customer service;
wherein the operating of the fluid control device is in response to receiving wireless control signals from a system control unit; and
wherein the fluid control device is operated according to a schedule received from a system control unit.

13. The method as recited in claim 12, wherein the system control unit is mobile and wherein the method further comprises transmitting signals from the system control unit to a controller to provide a schedule of actuations for the fluid control device that overrides any prior schedule of a customer.

14. The method as recited in claim 13, wherein the utility is water and the schedule implements at least one of weather-related restrictions, peak demand restrictions or an emergency condition.

15. The method as recited in claim 13, wherein the utility is water, the fluid control device is a valve and wherein the schedule is arranged for periodic actuations of the valve for maintenance reasons.

16. The method as recited in claim 12, wherein the utility is water and the fluid control device is a valve situated in an outlet line supplying a user device such that closing the valve does not stop supply to a meter on an intake line.

17. The method as recited in claim 12, wherein the customer device is at least one of a swimming pool, a spa and a hose outlet.

18. The method as recited in claim 12, wherein the fluid control device transmits signals to shut off downstream devices when the fluid control device is actuated to shut off supply of the utility to the fluid control device.

19. The method as recited in claim 12, further comprising transmitting current usage totals from a meter on the main customer service to the system control unit for comparison with usage criteria in at least one of the system control unit and a controller that controls the fluid control device.

20. The method as recited in claim 12, further comprising transmitting current usage totals from a meter on the main customer service to a controller that controls the fluid control device for comparison with usage criteria.

21. The method as recited in claim 12, wherein the system control unit is a radio signaling unit carried by a vehicle.

22. The method as recited in claim 12, wherein the system control unit is carried by a person collecting meter data on foot.
